(19) United States
(12) Patent Application Publication
(10) Pub. No.: US 2005/0078819 A1
(43) Pub. Date: Apr. 14, 2005

(54) Slim phone jack

(76) Inventors: Han-Cheng Hsu, Taoyuan Hsien (TW); Chih-Tse Chen, Taoyuan Hsien (TW); Ching-Man Kao, Taoyuan Hsien (TW)

Correspondence Address: GLENN PATENT GROUP, 3475 EDISON WAY, SUITE L, MENLO PARK, CA, 94025, US

(21) Appl. No.: 10/780,807

(22) Filed: Feb. 17, 2004

(30) Foreign Application Priority Data
Oct. 9, 2003 (TW) 92128194

(51) Int. Cl. H04M 1/00; G06F 17/00

(52) U.S. Cl. 379/441

(57) ABSTRACT

A slim phone jack is described. A height of the slim phone jack is reduced so as to reduce a height of an electric device utilized the slim phone jack. The slim phone jack has an upper cover, a lower cover and two sidewalls, and is suitable to couple to a phone plug with a spring arm. An inside of the upper cover has contact terminals. The two sidewalls form a sliding tunnel for inserting the phone plug easily. The lower cover further has a guiding slot. The slim phone jack further couples to a circuit board having a fixing slot. When the phone plug is inserted into the slim phone jack, the spring arm sticks out of the guiding slot so that a fixing edge of the spring arm couples to the fixing slot of the circuit board to fix the phone plug in the slim phone jack more strongly.

### FIELD OF THE INVENTION

The present invention relates to a slim phone jack, and especially, to a slim phone jack for a telephone or a network.

### BACKGROUND OF THE INVENTION

Information technology and the network industry are highly developed now. People utilize networks to search for information and provide services. Hence, the growing network provides humans with a comfortable and fast information search environment.

At this time, there is a lot of information to be distributed over the network. Therefore, a network established with only a few computers provides insufficient service. Network systems are established with more computers and the computer apparatuses may even be distributed in different places all over the world. The computer apparatuses, such as workstations, servers, database memory, routers, and backup devices, connect with each other via the network. Nowadays, almost every personal computer provides an interface to access the network, and even a notebook computer or a palm computer provides Internet functions.

These computer apparatus connecting to each other via the network need a connector to couple to directly the network or a network relative equipment, such as a hub or the like.

The volume of the network equipment or computer apparatus is decreased because electrical product manufacture technology has made great progress. For example, the size and the weight of the notebook computer are reduced.

A conventional connector for connecting the computer apparatus to the network or network-related equipment normally uses a standard RJ-45 phone jack and a standard RJ-45 phone plug. Each standard RJ-45 phone plug has to be inserted into each standard RJ-45 phone jack; the dimensions of the standard RJ-45 phone plug and the standard RJ-45 phone jack therefore have to fit exchangeable requirements. However, for a unit of electrical equipment, the dimensions of the standard RJ-45 connector become a bottleneck to size reduction thereof. Therefore, there is a need to reduce the size of the standard RJ-45 phone jack and the reduced RJ-45 phone jack still has to be compatible with the standard RJ-45 phone plug.

### SUMMARY OF THE INVENTION

One object of the present invention is to provide a slim phone jack with a reduced thickness so as to reduce the size of the electrical equipment with the slim phonejack.

Another object of the present invention is to provide a slim phone jack with a reduced volume to decrease the manufacture cost thereof.

A further object of the present invention is to provide a slim phone jack and a corresponding printed circuit board efficiently to fix the phone jack therein.

The present invention provides a slim phone jack suitable to couple to a phone plug, e.g. a RJ-45 phone plug, a RJ-12 phone plug, or a RJ-11 phone plug, with a spring arm. The slim phone jack has an upper cover, a lower cover, and two sidewalls.

The inside of the upper cover has a plurality of contact terminals to couple to a plurality of corresponding contact terminals of the phone plug. The two sidewalls couple to the upper cover and the lower cover to form a sliding tunnel convenient for the phone plug to couple with the slim phone jack. The lower cover has a guiding slot formed by an opening. The upper cover, the lower cover, and the two sidewalls form a rectangular connecting entry for the phone plug.

The spring arm sticks out of a surface of the lower cover by way of the opening. The spring arm further has a guiding block. The guiding block is guided by the opening of the guiding slot so that the corresponding contact terminals of the phone plug can further exactly couple to the contact terminals of the slim phone jack. The spring arm further has a fixing edge shifted according to a deformation of the spring arm. The fixing edge sticks out of a surface of the lower cover when the spring arm is free of force.

The spring arm further has a release arm for releasing the phone plug from the slim phone jack. The fixing edge can be pressed into the lower cover when the release arm is pressed.

The slim phone jack further has at least one fixing stud, at least one fixing foot, and a plurality of signal transmitting feet. The fixing stud fixes the slim phone jack on a printed circuit board. The fixing foot is welded effectively to fix the slim phone jack on the printed circuit board. The signal transmitting feet couple to circuits of the printed circuit board for transmitting signals therebetween. The slim phone jack can be a surface mount device (SMD) or a through hole device (THD).

The printed circuit board further has a fixing slot. The spring arm sticks out of a surface of the lower cover by way of the opening to couple to the fixing slot of the printed circuit board. Meanwhile, the fixing edge couples to a protrusion of the fixing slot. When the phone plug is released from the slim phone jack, a release arm is first pressed, then the fixing edge is released from the fixing slot of the printed circuit board, and therefore the phone plug can be easily released from the slim phone jack.

The height of the slim phone jack can be efficiently reduced, and therefore the thickness of the electrical equipment with the slim phone jack can also be efficiently decreased. The slim phone jack can couple to a corresponding standard phone plug having no dimensions modification. The slim phone jack further utilizes the printed circuit board with the fixing slot to couple firmly to the phone plug to enhance the signal transmission reliability.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A is a schematic view of a first preferred embodiment of a slim phone jack according to the present invention;

FIG. 1B is a schematic rear view of the first preferred embodiment of FIG. 1A;

FIG. 2 is a schematic rear view of a second preferred embodiment of a slim phone jack according to the present invention; and

FIG. 3 is an exploded view for illustrating an assembly relationship of the first preferred embodiment of FIG. 1A, a corresponding printed circuit board, and a corresponding phone plug.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

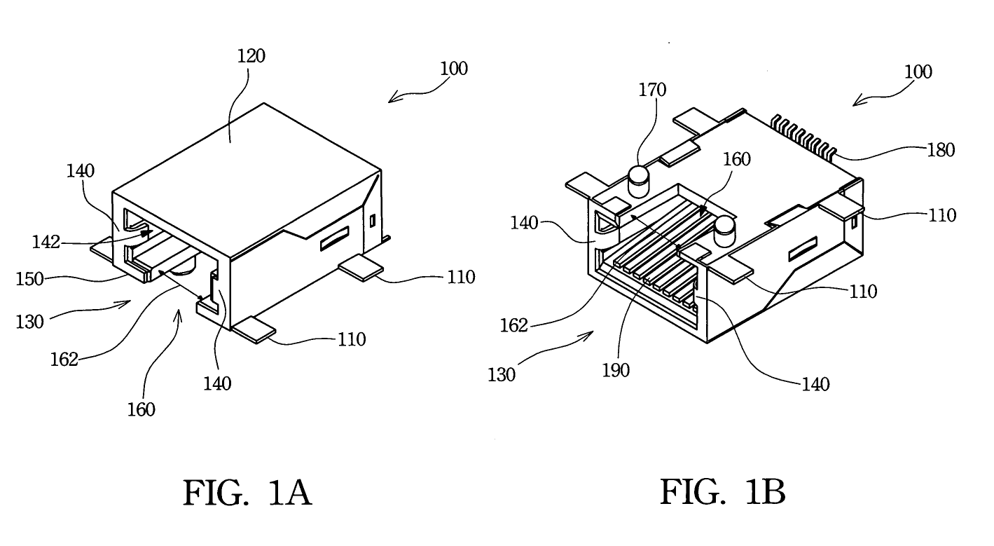

FIG. 1A is a schematic view of a first preferred embodiment of a slim phone jack according to the present invention and FIG. 1B is a schematic rear view thereof. The slim phone jack 100 has an upper cover 120, sidewalls 140, and a lower cover 150. An inside of the upper cover 120 further has contact terminals 190 connecting with contact terminals of a corresponding phone plug for transmitting signals. A slim phone jack 100 according to the present invention, for example a RJ-45 phone jack, has a pair of sidewalls 140 to form a sliding tunnel 142 for inserting a RJ-45 phone plug. Hence the RJ-45 phone plug can be inserted into a connecting entry 130 of the slim phone jack 100 along the sliding tunnel 142. The lower cover 150 further has a guiding slot 160 formed by an opening 162 for guiding the inserted RJ-45 phone plug to couple exactly the contact terminals of the corresponding phone plug to the contact terminals 190.

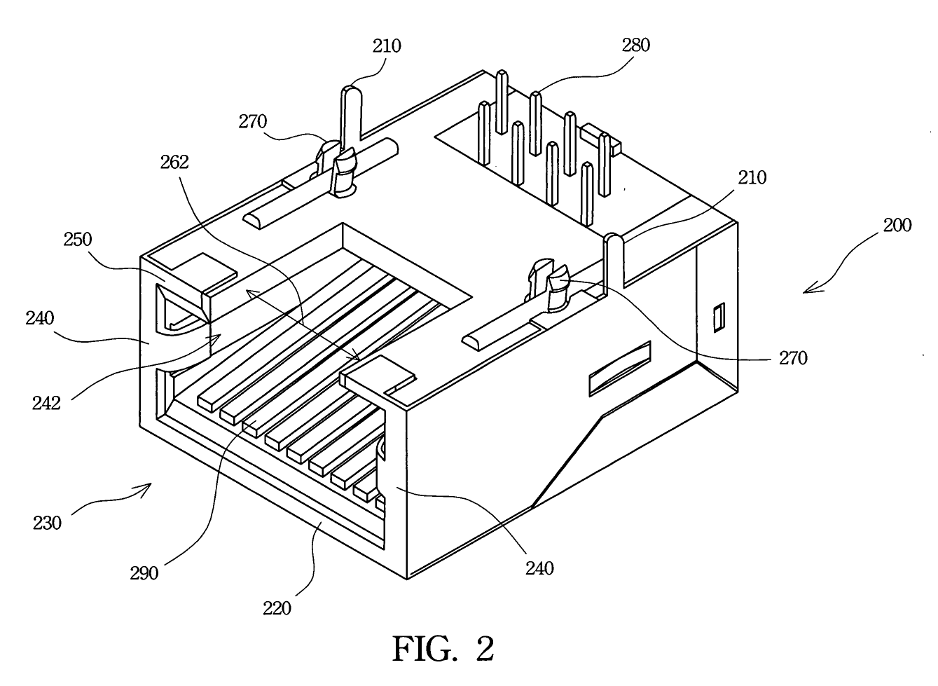

The slim phone jack according to the present invention is not only suitable for a surface mount device (SMD) but also suitable for a through hole device (THD). Referring to FIG. 1B, a rear side of a SMD type slim phone jack 100 further has fixing studs 170 for fixing the slim phone jack 100 on a printed circuit-board to guarantee exactly the welding dimensions thereof, fixing feet 110 for enhancing the welding strength therebetween, and signal transmitting feet 180 for transmitting signals therebetween. The first preferred embodiment of FIG. 1A and 1B illustrates a surface mount device and the second preferred embodiment of FIG. 2 illustrates a through hole device to describe clearly the fundamental structure and appearance thereof.

FIG. 2 is a schematic rear view of a second preferred embodiment of a slim phone jack according to the present invention. The second preferred embodiment of FIG. 2 is a THD type slim phone jack 200 utilized in a conventional through hole process. The slim phone jack 200 has an upper cover 220, sidewalls 240, and a lower cover 250. An inside of the upper cover 220 further has contact terminals 290 to connect with contact terminals of a corresponding phone plug, e.g. a RJ-45 phone plug, for transmitting signals. Sidewalls 240 of the slim phone jack 200 further form a sliding tunnel 242 for easily inserting the RJ-45 phone plug. Therefore, the RJ-45 phone plug is easily inserted into a connecting entry 230 of the slim phone jack 200 along the sliding tunnel 242. The lower cover 250 also has a guiding slot 260 formed by an opening 262 for further guiding the inserted RJ-45 phone plug.

Because the preferred embodiment is a THD type slime phone jack, a rear side of the slim phone jack 200 further has fixing studs 270, fixing feet 210, and signal transmitting feet 280. The fixing studs 270 conveniently locks the slim phone jack 200 on a corresponding printed circuit board to guarantee exactly welding dimensions thereof. The fixing feet 210 enhance the welding strength of the slim phone jack 200 and the corresponding printed circuit board. The signal transmitting feet 280 are utilized to transmit signals between the slim phone jack 200 and the corresponding printed circuit board.

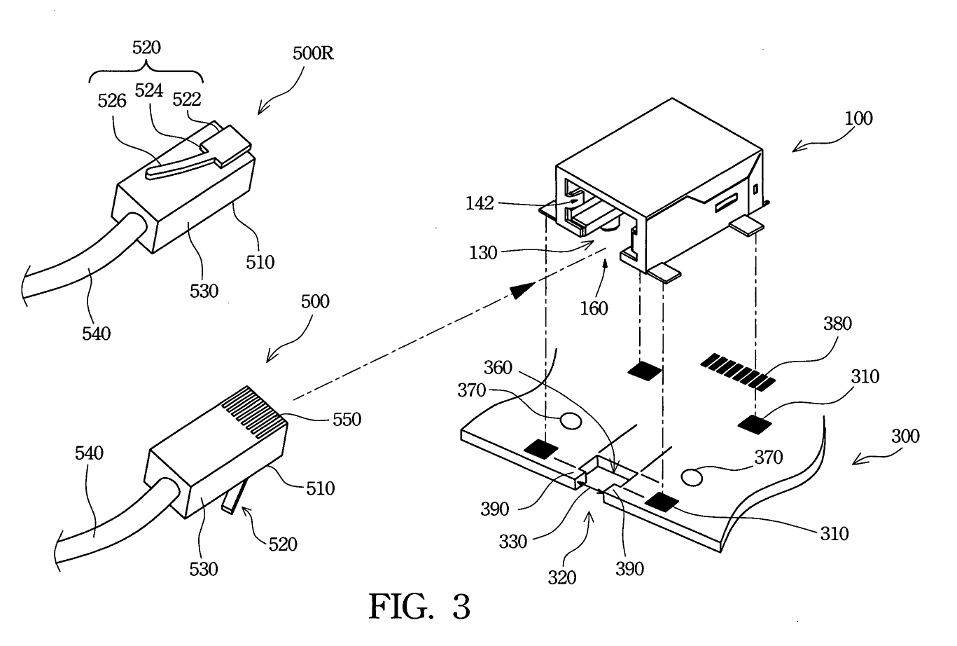

FIG. 3 is an exploded view for illustrating an assembly relationship of the first preferred embodiment of FIG. 1A, a corresponding printed circuit board, and a corresponding phone plug. The printed circuit board 300 has fixing pads 310, signal transmitting pads 380, a fixing slot 360, and at least one fixing hole 370.

The fixing hole 370 is coupled to the fixing stud 170 to provide an exact location of the slim phone jack 100 on the printed circuit board 300. The fixing pads 310 are utilized to fix with the fixing feet 110, and the signal transmitting pads 380 are fixed with the signal transmitting feet 180 to transmit signals therebetween. The fixing slot 360 provides a fixing force to couple phone plug 500 securely to the slim phone jack 100 after the phone plug 500 is inserted into the slim phone jack 100.

The phone plug 500 has a shell 510, contact terminals 550, a spring arm 520, contact terminals 550, and a transmitting cable 540. Referring to the rear view 500R of the phone plug 500, the spring arm 520 further has a guiding block 522, at least one fixing edge 524, and a release arm 526. Sidewalls 530 of the shell 510 couple to the sliding tunnel 142 when the phone plug 500 is inserted into the slim phone jack 100 so that the phone plug 500 is conveniently inserted into the connecting entry 130 of the slim phone jack 100. The guiding block 522 also guides the phone plug 500 when the phone plug 500 is inserted into the slim phone jack 100. The guiding block 522 guides the phone plug 500 to move forward along the guiding slot 160 until the contact terminals 550 are coupled to the contact terminals 190.

The transmitting cable 540 is utilized to couple to the network or an electrical equipment of the network for transmitting signals therein. When the phone plug 500 is inserted into the slim phone jack 100, the fixing edge 524 of the spring arm 520 is pressed by at least one protrusion 390 of the fixing slot 360 so that the spring arm 520 is deformed. When the contact terminals 550 are coupled to the contact terminals 190, the spring arm 520 rebounds because the fixing edge 524 already crossed the protrusion 390. At the moment, the fixing edge 524 hooks the protrusion 390 so that the spring arm 520 securely couples to the fixing slot 360 of the printed circuit board 300. Meanwhile, the contact terminals 550 of the phone plug 500 are securely coupled to the contact terminals 190 of the slim phone jack 100 so as to effectively guarantee signals transmission.

When the phone plug 500 is removed, the release arm 526 is first pressed toward the shell 510 and the fixing edge 524 is separated from the protrusion 390; that is to say, the fixing edge 524 is separated from the fixing slot 360. Therefore, the phone plug 500 can be released from the slim phone jack 100. The phone plug 500 is effectively fixed in the slim phone jack 100, which is cooperated with the fixing slot 360 and the opening 320 of the printed circuit board 300. The slim phone jack 100 is efficiently reduced in height, and therefore the thickness of the electrical equipment, which utilizes the slim phone jack 100, can be also reduced.

The opening 320 is a space where the release arm 526 can move, so the width of the opening 320 is wider than the width of the release arm 526. The fixing edge 524 preferably sticks out of a surface of the lower cover 150 of the slim phone jack 100 so that the fixing edge 524 can efficiently couple to the protrusion 390 of the printed circuit board 300 when the phone plug 500 is inserted in the slim phone jack 100.

The slim phone jack can provide a lower height phone jack to couple to a conventional RJ-45 phone plug. Therefore, the thickness of the electrical equipment with the slim phone jack according to the present invention can efficiently be reduced. The slim phone jack can provide a firm connection with the RJ-45 phone plug, and especially when the slim phone jack is combined with a printed circuit board with the fixing slot. The slim phone jack is preferably coupled with a standard RJ-45 phone plug. With different dimension designs, the slim phone jack can be also coupled to a different phone plug with corresponding dimensions, e.g. a RJ-11 or a RJ-12 phone plug.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. A slim phone jack for a phone plug with a spring arm, the slim phone jack comprising:
an upper cover with a plurality of contact terminals to couple to a plurality of corresponding contact terminals of the phone plug;
two sidewalls coupling to two sides of the upper cover, the two sidewalls forming a sliding tunnel allowing the phone plug to couple with the slim phone jack conveniently; and
a lower cover coupling to the two sidewalls, wherein the lower cover comprises a guiding slot formed by an opening.

2. The slim phone jack of claim 1, wherein the upper cover, the lower cover, and the two sidewalls form a rectangular connecting entry.

3. The slim phone jack of claim 1, wherein the spring arm sticks out of a surface of the lower cover by way of the opening.

4. The slim phone jack of claim 1, wherein the spring arm further comprises a guiding block and the guiding block is guided by the opening of the guiding slot of the lower cover so that the corresponding contact terminals of the phone plug exactly couple to the contact terminals of the slim phone jack.

5. The slim phone jack of claim 4, wherein the spring arm further comprises a fixing edge and the fixing edge is shifted according to a deformation of the spring arm, the fixing edge sticking out of a surface of the lower cover when the spring arm is free of force.

6. The slim phone jack of claim 4, wherein the spring arm further comprises a release arm for releasing the phone plug from the slim phone jack, the fixing edge being pressed into the lower cover when the release arm is pressed.

7. The slim phone jack of claim 1, wherein the slim phone jack further comprises:
at least one fixing stud for fixing the slim phone jack on a printed circuit board;
at least one fixing foot for fixing on the printed circuit board; and
a plurality of signal transmitting feet for coupling to circuits of the printed circuit board to transmit signals.

8. The slim phone jack of claim 7, wherein the slim phone jack is a surface mount device (SMD) or a through hole device (THD).

9. The slim phone jack of claim 1, wherein the slim phone jack is a slim RJ-45 phone jack, a slim RJ-12 phone jack, or a slim RJ-11 phone jack.

10. A slim phone jack for a phone plug with a spring arm, the slim phone jack comprising:
an upper cover with a plurality of contact terminals to couple to a plurality of corresponding contact terminals of the phone plug;
two sidewalls coupling to two sides of the upper cover, the two sidewalls forming a sliding tunnel to allow the phone plug to couple with the slim phone jack conveniently;
a lower cover coupling to the two sidewalls, wherein the lower cover comprises a guiding slot formed by an opening; and
a printed circuit board coupling to the lower cover, wherein the printed circuit board further comprises a fixing slot.

11. The slim phone jack of claim 10, wherein the upper cover, the lower cover, and the two sidewalls form a rectangular connecting entry.

12. The slim phone jack of claim 10, wherein the spring arm sticks out of a surface of the lower cover by way of the opening to couple to the fixing slot of the printed circuit board.

13. The slim phone jack of claim 10, wherein the spring arm further comprises a guiding block and the guiding block is guided by the opening of the guiding slot of the lower cover so that the corresponding contact terminals of the phone plug exactly couple to the contact terminals of the slim phone jack.

14. The slim phone jack of claim 13, wherein the spring arm further comprises a fixing edge and the fixing edge is shifted according to a deformation of the spring arm, the fixing edge sticking out of a surface of the lower cover to couple a protrusion of the fixing slot when the spring arm is free of force.

15. The slim phone jack of claim 14, wherein the spring arm further comprises a release arm for releasing the phone plug from the slim phone jack, the fixing edge being released from the fixing slot of the printed circuit board when the release arm is pressed.

16. The slim phone jack of claim 10, wherein the slim phone jack further comprises:
at least one fixing stud for coupling to at least one corresponding fixing hole to fix the slim phone jack on a printed circuit board;
at least one fixing foot for fixing on the printed circuit board; and
a plurality of signal transmitting feet for coupling to circuits of the printed circuit board to transmit signals.

17. The slim phone jack of claim 16, wherein the slim phone jack is a surface mount device (SMD) or a through hole device (THD).

18. The slim phone jack of claim 10, wherein the slim phone jack is a slim RJ-45 phone jack, a slim RJ-12 phone jack, or a slim RJ-11 phone jack.
